(19) United States
(12) Patent Application Publication
(10) Pub. No.: US 2010/0037973 A1
(43) Pub. Date: Feb. 18, 2010

(54) Flexible hose resistant to rollover

(76) Inventor: Stacy Smith, Simpsonville, SC (US)

Correspondence Address: Thomas A. O'Rourke;Bodner & O'Rourke, 425 Broadhollow Road, Melville, NY, 11747, US

(21) Appl. No.: 12/228,888

(22) Filed: Aug. 15, 2008

(51) Int. Cl. F16L 11/112; B32B 5/00

(52) U.S. Cl. 138/122; 138/138; 138/153; 138/145; 156/176; 138/134; 138/131

(57) ABSTRACT

An efficient flexible hose construction is provided which incorporates resistance, when subjected to high negative pressure loads, to the collapse failure known “rollover” or “shingling”. The construction relates to a means of increasing the torsion capability of a flexible hose where the hose is formed from a helical wire that is coated and thereafter is connected to and supports a shroud or cover. Improved resistance to rollover lies in mechanical enhancements to the interface between the helical wire and the coating material, where the enhancement assists in maintaining the wire and coating as an integral unit and prevents separation leading to shingling under high vacuum pressures. The mechanical enhancement requires use of a specialized cross-section for the helical reinforcing wire.

### FIELD OF THE INVENTION

This invention relates generally to flexible hose construction, and more particularly to a flexible hose construction capable of resisting rollover or “shingling” upon application of high negative pressures.

### BACKGROUND OF THE INVENTION

A hose, unlike its rigid counterpart in the form of a pipe, is flexible to some degree while serving a similar function—that of conveying a fluid from one location to another. Hoses may be utilized to conduct fluid in either a liquid or a gaseous state, and may be utilized to transport solids in the form of processed or particulate matter. Hoses have a multitude of military applications, such as the hoses which supply breathable oxygen to pilots, the probe and drogue in-flight refueling arrangement, hydraulic lines for actuation of system components including landing and flight control surface, etc. Hoses similarly have a role in many industrial applications, including chemical processing, fire suppression, petroleum product extraction and transport, material handling, and many others. Many flexible hoses also have home-based uses ranging from the garden hose to flexible replacement ducting for a home's forced-air heating/cooling system.

Hoses may be designed to operate in a range of environments—most often in ordinary atmospheric conditions, but also in underwater pumping operations, operations in toxic environments, and even in the vacuum of outer space on suits worn by astronauts during extra vehicular activates. Hoses may also conduct fluids which are themselves flowing under a range of conditions—high or low temperature, and high or low pressure. Although hoses very often tend to function in a role where a fluid is being pumped to a location under high pressure, and perhaps less often under low pressure conditions such as for hydraulic system return lines, it is in fact fairly common to use hoses where there is negative pressure or suction. The most common negative pressure applications may be the hoses of industrial and home vacuum systems.

These vacuum hoses may be made out of nylon, polyurethane, polyethylene, polyvinylchloride (PVC), natural or synthetic rubbers, or Teflon, and may incorporate metals such as stainless steel in the form of a spirally formed and coated wire. Utilization of hoses, particularly for a stretch hose or a self-retracting hose in a vacuum application, leads to concerns of a collapse failure known as “rollover,” in which the convolutions “shingle” and greatly deform and narrow what had been the inner diameter of the air path. As vacuum motors become more powerful to provide greater suction, stronger and stronger hoses are needed to prevent hose failure. As long as the helical wire's ability to resist torsion remains high, the adequately designed hose will not succumb to rollover under high suction loads.

The ability of the wires to resist torsion leads to two technical considerations. The first relates to the ability of the wire itself to resist torsion, which is given by the equation T=G*J*Θ/L, where G is the shear modulus of rigidity, J is the polar moment of inertia, Θ is the angle due to torque, and L is the length over which the angle is measured. Since the shear modulus is simply a material property—the reason for using steel wire as opposed to other lower strength choices, a critical factor in the torsion resistant ability of the wire is determined from the polar moment of inertia, which for a round cross-section is given by the equation J=(Π*r⁴)/2. With r being the radius of the wire, what may have been an intuitive deduction becomes apparent in mathematical form in that a wire with a greater radius or diameter will have a greater capability to resist torsion loading. But, the need for an efficient design based on practical concerns, such as the reduction in flexibility due to use of larger wire diameters and the increase in weight which affects mobility of the hose length for a vacuum unit, leads the hose designer to seek optimization of the other consideration which affects the ability of the wires to resist torsion.

For a chosen wire having a particular diameter and sheer modulus, another root cause of hose rollover involves the adhesive failure of the wire coating to the wire core, which is significant as the coating and hose cover provide significant support to constraining the wire helix and in linking one convolute to the next. As long as the wire coating remains intimately bonded to the wire, not only does the cover assist in resisting torsion, but the effective radius of the wire is also increased and contributes to the polar moment of inertia, J, thus increasing torsion resistance. Once shingling has occurred in one location, it will remain a weak point in the hose due to its lower torque resistance with the loss of a bond between the wire and the coating. Improvements which provide a better bond between the coating and the wire—either chemical or mechanical—would contribute to rollover-resistance with smaller wires.

Prior art improvements to hoses to prevent collapse failures are show by U.S. Pat. No. 6,607,010 to Kashy. The Kashy invention, as an improvement over a corrugated style sidewall, added an internally reinforced braided wall. Also, U.S. Pat. No. 6,390,141 to Fisher features elastomeric layers with a spiral reinforcing member interposed between the layers. But these approaches are aimed at a collapse failure occurring as a result of bending deformation of the wire helix, whereas shingling is the result of a torsion failure. Also, these approaches compromise hose flexibility to achieve gains in collapse resistance. There is little in the art aimed at reducing susceptibility of a flex hose to shingling. The invention disclosed herein improves the torsion capability of self-retracting hose without losses in flexibility or increased weight per unit length.

### SUMMARY OF THE INVENTION

A flexible hose has innumerable applications in military equipment and vehicles, in industrial machines and tools, and even in the home. These applications typically include conveying a fluid—either liquid or gas and sometimes even light weight solid or particulate matter—usually while under an applied pressure. In certain applications, a negative pressure or suction is used to create a vacuum effect to draw such media into and/or through a flexible hose. Although there are many such uses, including farm applications such as for drawing liquid fertilizer from a tank or in the harvesting of crops, the most well known is perhaps the basic vacuum cleaner.

As motors with increased power are utilized to achieve greater suction capability, the hose undergoing higher negative pressures becomes more susceptible to failure known as rollover. This failure mode, in which the torsional capability of the hose has been exceeded locally, may be traceable to bond failure between the helical wire reinforcing member and its coating, where the coating provides an appropriate contact surface for the cover.

A typical wire has a round cross-section to which the coating is applied, although it is not uncommon in the art to use oval, elliptical or even a square cross-section. But use of purely “rounded” cross-sections does not improve bond performance. A polygon in the form of a pentagon, a hexagon, or an octagon would provide improvements in bond performance, and in fact, virtually any polygon would provide improvements, even polygons which are not regular, meaning they do not having equal length sides and equal angles. However, the cross-section of a preferred embodiment of this invention, whether comprised of flat sides, curved sides, or a combination of the two, will incorporate one or more concave features to create a mechanical lock between the wire core and the coating. The mechanical lock proposed herein serves to increase the torsional capability of the hose, and therefore its resistance to rollover.

### OBJECTS OF THE INVENTION

It is an object of this invention to provide a hose which is capable of transmitting suction loads from one end to another end.

It is further object of this invention to provide a hose which may be flexibly utilized to transmit fluids.

It is another object of this invention to provide a construction for a hose that is light weight.

It is another object of this invention to provide a hose that is capable of resisting a collapse failure in the form of rollover, while negative pressure loads applied.

It is another object of this invention to provide a hose that is capable of resisting shingling of the hose convolutions, when utilized to transmit vacuum pressure.

It is another object of this invention to reduce bond failure between the wire reinforcing member of a flexible hose and its coating.

It is another object of this invention to prevent the wire coating of a flexible hose from rotating about its wire core.

It is another object of this invention to achieve increased torsion capability of a given hose without a substantial increase in the size or mechanical characteristics of the hose members.

### BRIEF DESCRIPTION OF THE DRAWINGS

FIG. 1 is a section view through a flexible duct of this invention.

FIG. 2 is an enlarged detail view of the flexible duct of FIG. 1.

FIG. 3 is an alternative cross-section for a helical wire reinforcement member.

FIG. 4 is a preferred cross-section for a helical wire reinforcement member.

FIG. 5 is a view of a flexible hose experiencing shingling in one section of the hose.

FIG. 6 is a view of a flexible hose which has experienced a rollover collapse throughout a large portion of the hose.

### DETAILED DESCRIPTION OF THE PREFERRED EMBODIMENT

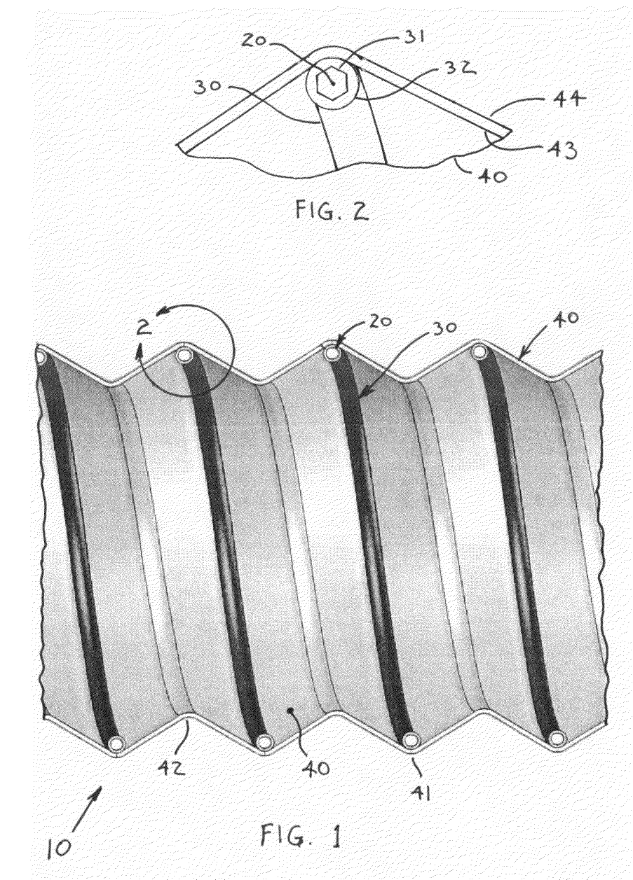

A section of flexible rollover-resistant hose 10 according to the invention is shown in FIG. 1. The ends of the hose may be constructed as needed for a particular application, and do not hold particular significance for the invention herein disclosed.

Flexible hose 10 is constructed, as is common for many flexible hoses, having a covering 40 that is stretched across and attached to a skeletal member that provides flexible structural support for the hose. The skeletal member is typically a wire reinforcing member 20 having a circular cross-section. The wire reinforcing member 20 may be manufactured out of nylon, a rigid polyvinyl chloride, or other composite material. However, the wire reinforcing member ideally must behave in a spring-like manner, part of which may be obtained by forming the member into a relatively small cross-section that follows a series of turns about a longitudinal axis. The turns each may need a minimal amount of spacing to create an interstitial open area, so as to more closely resemble the turns of a compression spring, rather than the turns of a tightly wound tension spring.

Forming the turns of the wire reinforcing member with a generous spacing or pitch may provide the hose with the flexibility needed for a particular application. The pitch of the turns may remain constant throughout the entire length of the hose, or alternatively, the pitch may be constant in one region, and then transition to have a different—increased or decreased—spacing in a successive region. Such regions with different pitch could provide the hose with greater flexibility in an area that may require tighter turns or a complex curved shape. Similarly, the radius of curvature of the turns may vary to provide an increased flow area in one region, or the radius of curvature of the turns may remain constant throughout the length of the flexible hose. Generally, the turns of the wire reinforcing member will be formed into helical shape, where the helix may be either left-handed or right-handed.

The member itself should not be very rigid, and conversely needs to possess resilient qualities to work cooperatively with the turns comprising the skeletal shape, while still possessing high strength characteristics. It is thus fairly common to have a wire reinforcing member made of drawn stainless steel. Also, although it is common to use only a single drawn wire, it is nonetheless possible to utilize a plurality of wires for the reinforcing member, where the wires may, but need not be, interconnected to each other. The necessary strength characteristics of the wire will become apparent in the later paragraphs.

In order for the hose to be developed into a flexible configuration, the cover 40 must be attached to the wire reinforcing member so as to accommodate flexure, while enclosing the interstitial area between turns to create a continuous inner surface 43 and outer surface 44. The cover 40 must also be generally impermeable to the fluids which the hose is expected to convey.

To accommodate flexure, the cover 40 may be attached so as to comprise a series of peaks 41 and valleys 42, whereby a certain excess of cover material may be allocated between an adjacent pair of turns of the wire reinforcing member to create a trough. The excess of material may work in conjunction with the flexible nature of the helical wire reinforcing member to increase the effective length of the hose.

The material of the cover 40 may also be of elastic material to assist in the flexible nature of the hose, or it may be preferable for it to be manufactured to be durable in nature, while remaining impermeable to the fluid conveyed.

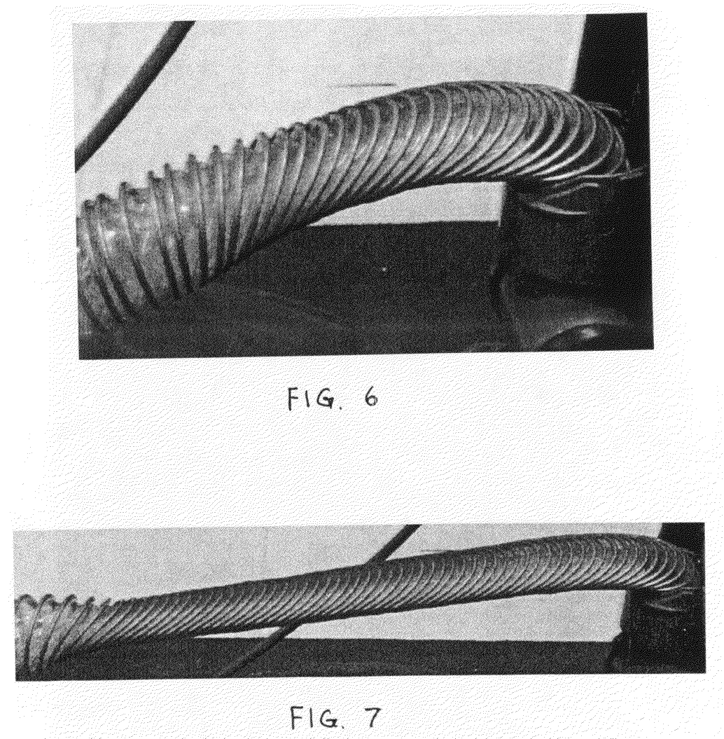

Attachment of the cover 40 to the wire reinforcing member 20 is not normally accomplished without an intermediary, which is generally a coating 30 applied to the wire reinforcing member 20. The coating 30 may serve a multitude of functions, but certainly serves to provide a more desirable contact area between cover and reinforcing member, which will understandably comprise a relatively small surface area of contact for bonding of the cover. The coating 30, being applied so as to completely encase the wire reinforcing member 20, will ordinarily maintain positive contact with wire reinforcing member 20. The inside surface 31 of coating 30 will generally conform to the exterior of the member 20, and normally will have an exterior surface 32 formed so as to have a circular cross-section (see FIG. 2).

Where flexible hoses of such construction are utilized in an application requiring suction or negative pressure to draw the fluid through the hose, the connection between the coating 30 and wire reinforcing member 40 may become critical. As a vacuum motor becomes more powerful to deliver greater suction capability—usually a key measure of performance for such machines—stronger and stronger hoses are required to prevent a collapse failure in the form of shingling of a flexible hose (See FIGS. 6 and 7).

The strength of the hose, in terms of resisting rollover or shingling, is a function of its torsional capability. The torsional capability of the hose may be considered to be the sum of the torsional capability of the wire reinforcing member itself, as well as that provided by its assemblage into the cover via the coating.

The torsional capability of the wire reinforcing member itself is given by the mathematical equation T=G*J*Θ/L, where G is the shear modulus of rigidity, J is the polar moment of inertia, Θ is the angle due to torque, and L is the length over which the angle is measured. The shear modulus of rigidity is a measure of strength and is dependent on the mechanical properties of the particular material chosen for the wire reinforcing member, and ranges from 0.0006 GPa for rubber, to 0.117 for Polyethylene, to 25.5 GPa for aluminum, and on up to 79.3 GPa for a steel. Unlike the shear modulus, the polar moment J is a geometric property varying with the wire's cross-sectional type and size.

The polar moment J, for a wire having a circular cross-section, is given by the equation J=(Π*r⁴)/2, where r is the radius of a wire. The significance of the shape and size of the wire's cross-section is apparent from the equation, because the radius of the wire is raised to the fourth power in the equation, so increases in the size of the wire's cross-section have a profound effect on its torsional capability. But, significant size increases have the opposite effect on the flexible nature of the helical wire-reinforcing member. That tradeoff may lead to an optimal wire size that is less than may be necessary to resist the torsion generated by negative pressures. But further increases in the polar moment occur from the coating 30 which is bonded to the wire, as the coating 30 effectively increases the radius to be utilized in the polar moment equation. The contribution may be significant, leading an adequately designed flexible hose to depend on the bonded coating.

Therefore, it is not surprising that among the root causes of hose collapse due to rollover is failure of the adhesive which connects the coating to the wire. When the wire to coating bond fails, it no longer provides any assistance to the wire in resisting the torque, leaving only the wire itself to resist torque which may then rotate inside the coating under a significantly smaller load. Once a hose has experienced shingling in one area because of failure of the wire coating bond, it will remain a weak point in the hose, and repeated cycling of the negative pressure may lead to propagation of the failed bond so as to have a lengthy section of a shingled hose (see FIG. 7). Preventing the wire coating from becoming detached from the wire would increase overall torque resistance, and therefore increase resistance to shingling.

The invention disclosed herein seeks to strengthen the bonded connection between the coating 30 and the wire reinforcing member 20 by the addition of a mechanical lock between the members. It is most common to utilize a drawn wire having a round cross-section for the reinforcing member. But, using such a smooth sided cross-section, even one such as an oval or an elliptical cross-section relies almost entirely on the shear capability of the adhesive connection to maintain the wire and coating as an integral unit. An improvement may be made by using a non-round cross-section in the form of a polygon, such as a pentagon or a hexagon shown in FIG. 3. While such multi-faceted polygons may assist somewhat in supplementing the capability of the adhesive in a manner analogous to a close-ended wrench on a hex-head bolt, it is very limited as it still largely relies on shear capability of the adhesive. This invention dramatically furthers the coating to wire connection by utilizing a wire with a cross-section that may comprise curved sides, a combination of flat and curved sides, or may comprise a polygon, but where those sides preferably create one or more concave features to create a more effective connection, or rather a mechanical lock between the members. The cross-section may even comprise a concave polygon—one having an interior angler that measures greater than 180 degrees, or it may combine features of a concave polygon with curved sides.

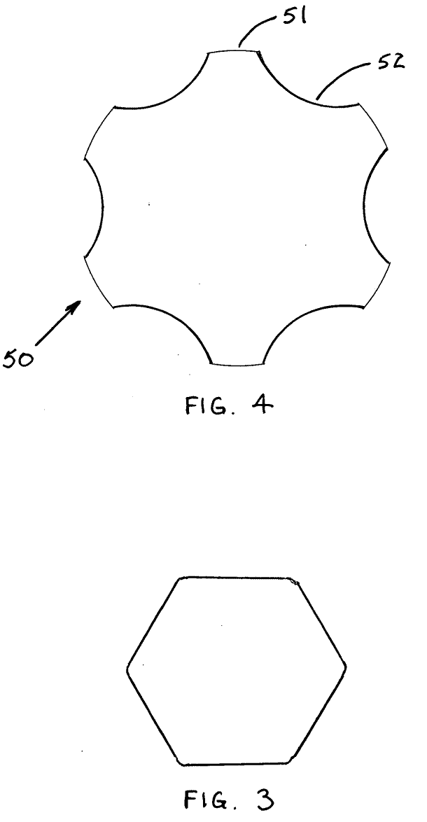

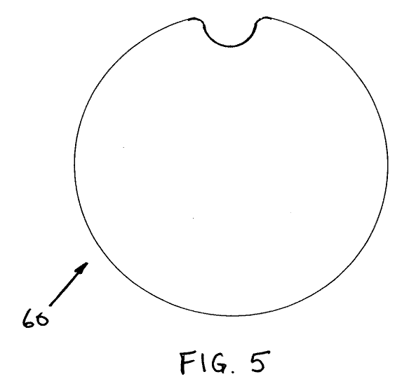

The cross-section proposed herein may thus take many different forms, and the cross-section 50 shown in FIG. 4 is merely meant to be exemplary. The cross-section 50 comprises a series of convex sides 51 which are connected by as many concave sides 52. The convex and concave sides are each shown as a circular arc, but may also have been elliptical or any other curved or compound curve. The combination of concave and convex sides of cross-section 50 creates a mechanical lock between the coating 30 and wire reinforcement member 20.

The cross-section cited herein need not be symmetrical as is the case in the exemplary cross-section 50, and may take the more simple asymmetric form of cross-section 60 in FIG. 5 in which the wire is knurled. Even this embodiment, which has only a single locking feature, may enhance bonding performance, as portions of the interface between the coating and wire are configured to react normal forces or compressive forces, rather than primarily shearing forces reacted almost exclusively by the adhesive.

Other modifications, substitutions, omissions and changes may be made in the design, size, materials used or proportions, operating conditions, assembly sequence, or arrangement or positioning of elements and members of the preferred embodiment without departing from the spirit of this invention as described in the following claims.

We claim:

1. A flexible hose, for use in applications requiring a light weight, rollover-resistant conduit to convey fluids and certain solids under negative pressure or suction, said flexible hose comprising:
(a) a wire reinforcement member, said wire reinforcement member having a cross-section, and said wire reinforcement member being formed generally into a series of flexible turns about a longitudinal axis each with a spacing from an adjacent one of said turns to create an interstitial area;
(b) a coating material, said coating material being formed about and bonded to said cross-section of said wire reinforcement member, said coating having an inner surface and an outer surface, said inner surface forming a mechanical lock with said cross-section of said wire reinforcement member; and
(c) a flexible cover, said cover being generally bonded or otherwise secured to said outer surface of said coating material, said cover forming a surface to encapsulate said interstitial area of each of said turns of said coated reinforcement member, said surface of said cover being generally impermeable to fluids.

2. A flexible hose according to claim 1 wherein said cross-section of said wire reinforcing member is comprised of at least one linear side and at least one curved side.

3. A flexible hose according to claim 2 wherein said at least one linear side and said at least one curved side forms one or more concave features.

4. A flexible hose according to claim 1 wherein said cross-section of said wire reinforcing member is comprised of at least two linear sides separated by at least one curved side.

5. A flexible hose according to claim 4 wherein said at least two linear sides separated by at least one curved side forms one or more concave features.

6. A flexible hose according to claim 1 wherein said cross-section of said wire reinforcing member is comprised of at least two curved sides separated by at least one linear side.

7. A flexible hose according to claim 6 wherein said at least two curved sides separated by at least one linear side forms one or more concave features.

8. A flexible hose according to claim 1 wherein said cross-section of said wire reinforcing member is comprised of a plurality of curved sides.

9. A flexible hose according to claim 8 wherein said plurality of curved sides forms one or more concave features

10. A flexible hose according to claim 1 wherein said cross-section of said wire reinforcing member is a polygon, said polygon being comprised of at least five sides.

11. A flexible hose according to claim 10 wherein said polygon of at least five sides forms one or more concave features.

12. A flexible hose according to claim 1 wherein said cross-section is asymmetric.

13. A flexible hose according to claim 1 wherein said turns of said wire reinforcement member have a non-constant spacing.

14. A flexible hose according to claim 1 wherein said turns of said wire reinforcement member have a non-constant radius of curvature.

15. A flexible hose according to claim 1 wherein said turns of said wire reinforcement member have a generally constant spacing.

16. A flexible hose according to claim 15 wherein said turns of said wire reinforcement member have a generally constant radius of curvature.

17. A flexible hose according to claim 16 wherein said turns of said wire reinforcement member form a helical shape.

18. A flexible hose according to claim 17 wherein said helix is left-handed.

19. A flexible hose according to claim 17 wherein said helix is right-handed.

20. A flexible hose according to claim 1 wherein said wire reinforcement member is drawn from a metallic material.

21. A flexible hose according to claim 20 wherein said metallic material is a high tensile steel.

22. A flexible hose according to claim 1 wherein said wire reinforcement member is comprised of one or more individual wires.

23. A flexible hose according to claim 1 wherein said outer surface of said coating has a circular cross-sectional shape.

24. A flexible hose according to claim 1 wherein said coating is formed out of a plastic material.

25. A flexible hose according to claim 1 wherein said cover is formed from a material selected from the group consisting of: nylon; polyurethane; polyethylene; polyvinylchloride; natural rubber; and synthetic rubber.

26. A flexible hose according to claim 1 wherein said cover is formed with excess material between said interstitial spaces to create folds.

27. A method for constructing a flexible rollover-resistant hose, for use in conveying fluids and certain solids under negative pressure or suction, said method comprising:
(a) forming one or more wires of specified cross-section generally into a series of flexible turns about a longitudinal axis each with a spacing from an adjacent one of said turns to create an interstitial area;
(b) applying a coating material to said wire, said coating material being formed about and bonded to said wire reinforcement member to have an inner surface in contact with said wire reinforcement member and an outer surface, said inner surface forming a mechanical lock with said specified cross-section of said wire reinforcement member; and
(c) bonding or otherwise securing a flexible cover to said outer surface of said coating material to form a surface to encapsulate said interstitial area of each of said turns of said reinforcement member, said surface of said cover being generally impermeable to fluids.

28. A method of constructing a flexible hose according to claim 27 wherein said specified cross-sectional shape of said wire comprises one or more concave features.
